(19) United States
(12) Patent Application Publication
(10) Pub. No.: US 2007/0209636 A1
(43) Pub. Date: Sep. 13, 2007

(54) Method for operating an internal combustion engine

(76) Inventors: Markus Ammann, Waiblingen (DE); Bernd Christner, Huelben (DE); Nicholas Fekete, Stuttgart (DE); Matthias Klingebiel, Waiblingen (DE); Ruediger Pfaff, Stuttgart (DE)

Correspondence Address: KLAUS J. BACH, 4407 TWIN OAKS DRIVE, MURRYSVILLE, PA, 15668, US

(21) Appl. No.: 11/699,196

(22) Filed: Jan. 29, 2007

Related U.S. Application Data
(63) Continuation-in-part of application No. PCT/EP05/08187, filed on Jul. 28, 2005.

(30) Foreign Application Priority Data
Jul. 30, 2004 (DE) 10 2004 037 053.2

(51) Int. Cl. F02M 7/00; F02M 25/07; F02B 47/08

(52) U.S. Cl. 123/435; 123/568.21

(57) ABSTRACT

In a method for operating an internal combustion engine, in particular an auto-ignition internal combustion engine, having at least one combustion chamber in which an air/fuel mixture is formed, and recirculated exhaust gas is admixed to the combustion air, a base setting of the exhaust gas recirculation rate is established as a function of a first characteristic operating variable, the exhaust gas recirculation rate is adjusted depending on at least one of the first and a second characteristic operating variable, and, in order to optimize combustion, the exhaust gas recirculation rate is adjusted a second time on the basis of a combustion noise measurement.

This is a Continuation-In-Part application of pending international patent Application PCT/EP2005/008187 filed 07/28/05 and claiming the priority of German patent application 10 2004 037 053.2 filed Jul. 30, 2004.

### BACKGROUND OF THE INVENTION

The invention relates to a method for operating an internal combustion engine, in particular an internal combustion engine with compression ignition having at least one combustion chamber for burning therein a mixture of fuel and air to which exhaust gas is admixed.

It is generally known in internal combustion engines to re-circulate exhaust gas (EGR) in order to reduce the exhaust gas emissions of the internal combustion engine. Here, part of the exhaust gas from the exhaust side of the internal combustion engine is returned to the intake side of the internal combustion engine and is admixed to the combustion air.

In a conventional embodiment of an EGR control system, a base setting of the EGR rate is adjusted for example as a function of the speed or torque of the internal combustion engine, so that a determined exhaust gas quantity is recirculated to the intake air. In a known embodiment of the conventional exhaust gas recirculation control system, an adaptation or regulation of the EGR base setting is carried out. The aim of this is to adapt the initially set EGR rate in accordance with a changing driving situation. A load-dependent reference variable is generally incorporated in order to correct a set EGR rate.

For an EGR regulating system, the intake combustion air is conventionally measured and it is sought to provide for indirect control of the EGR rate by means of the detected air mass flow rate. For this purpose, a hot film air mass flow sensor can be used, the signal of which is incorporated in the adjustment of the EGR rate. In modern internal combustion engines, in particular in diesel internal combustion engines, a control system of this type does not provide the required accuracy, since the new combustion methods demand rapid and load-point-dependent EGR regulation.

It is the principal object of the present invention to provide an exhaust gas recirculation control system which permits optimum operation of the internal combustion engine and, at the same time, reduces pollutant emissions.

### SUMMARY OF THE INVENTION

In a method for operating an internal combustion engine, in particular an auto-ignition internal combustion engine, having at least one combustion chamber in which an air/fuel mixture is formed, and recirculated exhaust gas is admixed to the combustion air, a base setting of the exhaust gas recirculation rate is established as a function of a first characteristic operating variable, the exhaust gas recirculation rate is adjusted depending on at least one of the first and a second characteristic operating variables, and, in order to optimize combustion, the exhaust gas recirculation rate is adjusted a second time on the basis of a combustion noise measurement.

In order to optimize combustion, according to the invention, a second adjustment or adaptation of the EGR rate is carried out as a function of a noise level of the combustion. In this way, the EGR rate can be varied by means of the noise level in the combustion chamber of the internal combustion engine as a function of the load point and can be rapidly adjusted. Stable operation with reduced nitrogen oxide and particulate emissions in the exhaust gas, and with high efficiency, is therefore ensured in particular in the new combustion methods of diesel internal combustion engines.

In one preferred embodiment of the invention, a determination of the noise level is carried out by means of a sensor. The sensor is arranged, for example, on the cylinder head of the internal combustion engine. The sensor is preferably arranged at a suitable point on or in the combustion chamber wall for detecting the combustion noises. Alternatively, a combustion chamber sensor can be attached to each cylinder of the internal combustion engine, so that, if required, targeted and separate adaptation or adjustment of the EGR rate can be carried out for each individual cylinder. For this purpose, a piezoelectric body-borne noise pick-up can be used as a sensor. It is therefore possible to provide for advantageous adaptation or control of the EGR rate in particular in conjunction with the modern diesel internal combustion engines, so that nitrogen oxide emissions can be considerably reduced. In addition, the invention also makes it possible to keep the combustion noise low.

In a further preferred embodiment of the invention, the noise measurement of the combustion is calculated by means of a signal of a cylinder pressure measurement carried out during the combustion. For this purpose, a sensor is used which is for example provided on the cylinder head or in the combustion chamber of the internal combustion engine. In this way, it is possible for further characteristic combustion variables, such as combustion duration, combustion profile, the epicenter of the combustion and further engine parameters to be determined. These can also be used, in addition to the EGR regulation, for controlling and regulating the combustion, in particular in diesel engines with a combined homogeneous/heterogeneous operating mode.

According to a further refinement of the invention, during the first base setting, the exhaust gas recirculation rate is at least 10% or between 10% and 65%. The present invention is particularly suitable for internal combustion engines in which it is possible to set an EGR rate of in particular between 35% and 65%, since there is a direct relationship between the EGR rate and the noise level during combustion in this range. The present invention is preferably used in internal combustion engines, in particular in diesel combustion engines, in which the noise level of combustion decreases with increasing EGR rate.

According to a further embodiment of the invention, the second adjustment or adaptation of the exhaust gas recirculation rate is carried out as a function of a correction value which is formed from a difference between the determined noise level and a nominal noise level. This makes it possible to provide for precise and relatively fast control of the EGR rate, and therefore permits optimized combustion. The nominal noise level is preferably determined as a function of a load-point-dependent nominal exhaust gas recirculation rate or as a function of the speed and/or load.

In a further preferred embodiment of the invention, the invention is used in internal combustion engines in which a combined homogeneous/heterogeneous operating mode with auto-ignition is present, so that the adjustment or adaptation of a nominal exhaust gas recirculation rate is carried out as a function of the load point.

The invention will become more readily apparent from the following description of exemplary embodiments of the invention described below with reference to the accompanying drawings:

### BRIEF DESCRIPTION OF THE DRAWINGS

FIG. 1 is a schematic illustration of an internal combustion engine with exhaust gas recirculation,

FIG. 2 shows the relationship between an EGR rate and a noise level of a combustion of the internal combustion engine according to FIG. 1, and

FIG. 3 is a schematic illustration of a first and a second EGR system according to the invention.

### DESCRIPTION OF PARTICULAR EMBODIMENTS

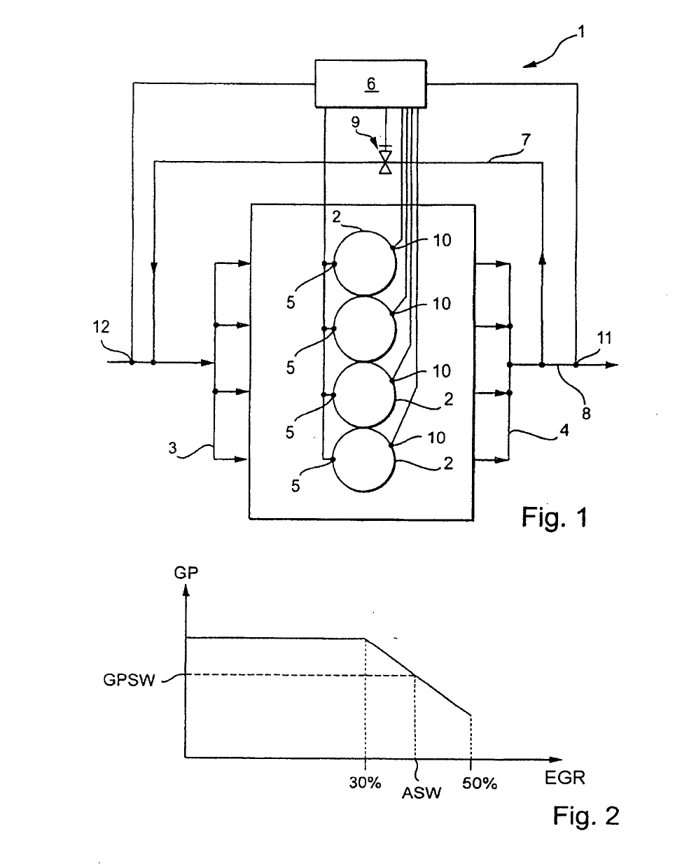

The internal combustion engine 1 illustrated in FIG. 1 has a plurality of cylinders 2, each including a combustion chamber delimited between a cylinder head and a piston in each cylinder 2. Fuel is supplied to the combustion chambers, and is mixed there with combustion air. Auto-ignition of the mixture which is formed takes place by means of compression, though the mixture can alternatively be ignited by a spark. The present invention is in particular not restricted to a specific type of internal combustion engine. The combustion air is supplied to the combustion chamber in a known way by means of an intake manifold 3, to which all the cylinders 2 are connected by means of their intake ducts (not illustrated). Combustion exhaust gases are discharged from the cylinders 2 via exhaust ducts (not illustrated) which open out into a common exhaust gas collecting line 4. In order to supply to the cylinder the required fuel, a fuel injector 5 is arranged in each cylinder 2, which fuel injector 5 injects fuel directly into the combustion chamber, or possibly into the intake duct or the intake passages. The injection parameters such as beginning of injection, injection duration, injection time and timing of individual partial injections are regulated and controlled by means of a control unit 6 as a function of different characteristic operating variables such as for example load, speed and the oxygen proportion in the exhaust gas of the internal combustion engine.

In order to optimize the combustion, according to the invention, an exhaust gas recirculation (EGR) system is provided, which EGR system serves to reduce the pollutant emissions in the exhaust gas. For this purpose, the internal combustion engine 1 is connected at its inlet side by an EGR line 7 to an exhaust gas line 8 in order to recirculate exhaust gases. The recirculated exhaust gas quantity is metered by means of an EGR valve 9 which is connected to the control unit 6 and is controlled in this way so as to set a determined EGR rate.

According to the present invention, the exhaust gas recirculation rate is controlled based on a noise level of the combustion. In auto-ignition internal combustion engines in particular, the noise level constitutes a characteristic variable which, as per FIG. 2, has a direct relationship with a present EGR rate. In this way, the engine controller 6 receives information from the signal of the noise level GP regarding the actual value of the EGR rate. According to FIG. 2, the noise level decreases as the EGR rate increases in certain regions, for example between 10% and 50%. The noise level of the combustion is determined as a characteristic variable for EGR control preferably by means of a sensor 10 which is provided in each cylinder 2 on or in the combustion chamber wall. Alternatively, the sensor 10 can project into the respective combustion chamber. The mixture to be burned can therefore be prepared to the best possible degree. This results in optimum load-dependent combustion.

Preferably, a piezoelectric engine body noise sensor is used as a sensor 10, though any suitable sensor type can be used. It is therefore possible, in particular in modern diesel internal combustion engines, to provide optimum adaptation or control of the EGR rate in such a way that nitrogen oxide emissions are considerably reduced. In addition, combustion with a high degree of efficiency is also ensured.

According to the invention, a combustion chamber sensor 10 can be attached to each cylinder 2 of the internal combustion engine 1, so that targeted adaptation or adjustment of the EGR rate can be performed for each individual cylinder 2. For this purpose, a determined EGR quantity is supplied to and varied in each individual cylinder 2 in a targeted fashion by means of a suitable EGR line or lines.

But it is also possible to assign the noise of a single pickup which is attached to a suitable point, for example to the cylinder head of the internal combustion engine, to the individual cylinders as a function of the cylinder ignition sequence. It is therefore possible to carry out a separate measurement of the noise level in conjunction with an EGR control device which makes it possible to control the EGR rate separately for each cylinder 2. This provides separate control of the EGR rate for each individual cylinder 2.

In addition or as an alternative to the above embodiment, information regarding the combustion can be derived from a cylinder pressure measurement signal from which the noise level of the combustion can likewise be determined. For this purpose, the respective signal is processed in the control unit 6 on the basis of a characteristic diagram stored in the control unit or from a formula, and the noise level is calculated from said processed signal.

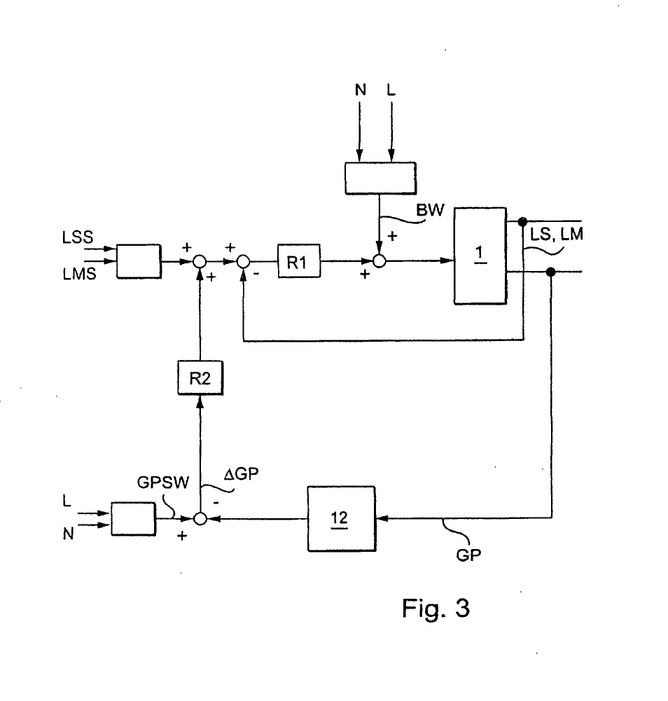

According to the present exemplary embodiment according to FIG. 3, during operation of the internal combustion engine 1, initially a base value BW of the EGR rate is set for example as a pilot control variable as a function of the load point. Characteristic operating variables such as the instantaneous engine speed N and/or the instantaneous load L are particularly suitable for this purpose. But other characteristic operating variables may also be used. In order to provide improved operation, the set base value BW is conventionally changed or controlled as a function of a lambda signal LS and/or a determined air mass flow rate LM by using a first controller R1. The corresponding lambda signal LS is delivered to the control unit 6 by means of a lambda probe 11, with the air mass flow rate being determined by a hot film air mass flow sensor 12.

In order to further optimize the present operation according to the invention, a noise level GP is determined by means of the sensor 10 and is further processed by means of a signal processing device 6, for example a band pass filter. The signal processing can take place by way of band pass filtering of the noise signal in a determined frequency range. A comparison is then made with a nominal noise level value GPSW in order to form a correction value ΔGP. The nominal noise level value GPSW is preferably selected as a function of the operating point of the internal combustion engine 1.

In addition, a further change to the set EGR rate is carried out as a function of the correction value ΔGP by means of a second controller R2. For this purpose, a further characteristic variable can be incorporated as per FIG. 3 in the form of a nominal EGR value ASW for the second adjustment of the EGR rate. The nominal EGR value ASW is preferably determined as a function of a nominal lambda value LLS and/or of a nominal air quantity value LMS. In this way, the EGR rate in the combustion chamber of the internal combustion engine is adapted by means of the determined noise level GP as a function of load point and is changed or adjusted rapidly.

The present invention is particularly suitable for auto-ignition internal combustion engines regardless of fuel type. For example, the operation of auto-ignition internal combustion engines with pre-injections and/or post-injections can be optimized in a targeted fashion. The present method can be used to optimum effect in particular in modern combustion methods where it is possible to set an EGR rate of 10% to 65%. The present invention provides significant advantages and the best results if an EGR rate of between 35% and 65% or 40% and 60% with regard to the exhaust gas emissions is provided. Optimum operation of the internal combustion engine 1 is likewise provided by the method according to the invention at an EGR rate of between 40% and 65%.

The invention relates to a method for operating an internal combustion engine, in particular, an auto-ignition internal combustion engine, having at least one combustion chamber in which an air/fuel mixture is formed, and recirculated exhaust gas is admixed to the combustion air. According to the invention, a base setting of the exhaust gas recirculation rate is set as a function of a first characteristic operating variable, with a first adaptation of the exhaust gas recirculation rate being carried out as a function of the first and/or a second characteristic operating variable. In order to optimize combustion, according to the invention, a further, second adaptation of the exhaust gas recirculation rate is carried out as a function of the measured combustion noise.

The present invention is particularly suitable for modern diesel engines which are operated as a function of the load point either with partially homogeneous combustion or with standard diesel combustion. Standard diesel combustion primarily involves automatic ignition of a heterogeneous mixture, while partially homogeneous diesel combustion involves, for example, a combined homogeneous/heterogeneous operation with multiple clocked pilot injections, a main injection and if appropriate a post-injection. Different EGR rates are set or required in these diverse combustion methods, so that in the event of a switch between standard diesel combustion and partially homogeneous combustion, large steps can occur in the setting of the EGR rate required in each case, for example between the nominal EGR rates. The method according to the invention makes it possible for such a switch to take place precisely and reliably within a short time.

The partially homogeneous combustion preferably takes place in the lower and middle load ranges. Here, the clocked pilot injection takes place in the compression stroke, with the main injection and post injection taking place in succession at a later point in time, preferably at a higher injection pressure than during the pilot injection. In addition, the present invention is suitable for internal combustion engines in which variable valve control is used. This permits advantageous and load-dependent adjustment of the EGR rate in particular in a combined homogeneous/heterogeneous operation, so that optimum operation of the internal combustion engine with low pollutant emissions is ensured.

What is claimed is:

1. A method for operating an internal combustion engine having at least one combustion chamber which is delimited between a piston and a cylinder head and in which an air/fuel mixture is formed and burned, comprising the steps of
admitting recirculated exhaust gas to the combustion air,
controlling the base setting for the exhaust gas recirculation rate as a function of a first characteristic operating variable,
establishing a first control setting or adjustment of the exhaust gas recirculation rate as a function of at least one of the first and a second characteristic operating variable, and
providing a second setting or adjustment of the exhaust gas recirculation rate as a function of a noise level of the combustion.

2. The method as claimed in claim 1, wherein the noise level is determined by means of a sensor.

3. The method as claimed in claim 2, wherein the sensor is arranged on the cylinder head of the internal combustion engine.

4. The method as claimed in claim 1, wherein the noise level of the combustion is calculated from a signal of a cylinder pressure measurement carried out during the combustion.

5. The method as claimed in claim 1, wherein, during the first base setting, an exhaust gas recirculation rate of between 10% and 65% is provided.

6. The method as claimed in claim 1, wherein the second setting or adjustment of the exhaust gas recirculation rate is carried out as a function of a correction value which is formed from a difference between the determined noise level and a nominal noise level.

7. The method as claimed in claim 1, wherein the nominal noise level of the second setting or adjustment of the exhaust gas recirculation rate is determined as a function of a load-point-dependent nominal exhaust gas recirculation rate.

8. The method as claimed in claim 7, wherein, in a combined homogeneous/heterogeneous operating mode of an internal combustion engine with auto-ignition, the adjustment or adaptation of the nominal exhaust gas recirculation rate is carried out as a function of the load point.

9. The method as claimed in claim 7, wherein the nominal exhaust gas recirculation rate is between 35% and 65%.

10. The method as claimed in claim 7, wherein the normal exhaust gas recirculation rate is between 40% and 60%.
